(19) United States
(12) Patent Application Publication
(10) Pub. No.: US 2015/0252906 A1
(43) Pub. Date: Sep. 10, 2015

(54) FLOW CONTROL DEVICE WITH VARIANT ORIFICE

(71) Applicant: Swagelok Company, Solon, OH (US)

(72) Inventor: William H. Glime, III, Chagrin Falls, OH (US)

(21) Appl. No.: 14/636,410

(22) Filed: Mar. 3, 2015

Related U.S. Application Data
(60) Provisional application No. 61/949,448, filed on Mar. 7, 2014.

(51) Int. Cl. F16K 1/52

(52) U.S. Cl. CPC F16K 1/52

(57) ABSTRACT

A flow control device includes a seal element and a flow element that in a first position presents a first flow area and in a second position presents a second flow area. Also presented is a flow element with a variant orifice for a flow control device. The flow element may have a hollow body and at least one flow opening in a wall of the hollow body. In another embodiment, the at least one flow opening may have a first flow area at a first position relative to a reference axis and a second flow area at a second position relative to the reference axis. An embodiment of a seal element is presented in which the seal element includes a first portion, a second portion, and a transition portion that joins the first portion and the second portion. The transition portion isolates the second portion from stresses applied to the first portion.

### RELATED APPLICATIONS

This application claims the benefit of pending U.S. Provisional patent application Ser. No. 61/949,448 filed on Mar. 7, 2014, for FLOW CONTROL DEVICE WITH VARIANT ORIFICE, the entire disclosure of which is fully incorporated herein by reference.

### BACKGROUND OF THE DISCLOSURE

The inventions relate to fluid delivery arrangements, and more particularly to flow control devices such as valves that may be used to control or regulate or meter fluid flow. Valves are well known for use as flow control devices for gas and liquid fluid delivery and control. In the semiconductor industry as well as others, delivery of process chemicals during various processing operations is controlled using valves, for example, high purity valves. Some of the more common applications for valves are chemical vapor deposition (CVD) and atomic layer deposition (ALD). Some valves are used as metering valves in which an actuator or other control device is used to adjust, change or control fluid flow rate through an orifice. Needle valves are traditionally used to provide a metering operation, with a tapered stem tip being used to change the effective flow area of a fixed orifice. But, flow control through needle valves can be susceptible to instability due to flow influences on the stem tip. Additionally, needle valves can exhibit difficulties with repeatable flow rate after changing the position of the needle.

### BRIEF DESCRIPTION OF THE DRAWINGS

FIG. 1 illustrates an exemplary flow control device and actuator in longitudinal cross-section along an axis X, and that may incorporate the teachings herein,

FIG. 2 is an enlarged view of the circled portion of FIG. 1 with the flow control device in a maximum flow position,

FIG. 3 is an enlarged view of the circled portion of FIG. 1 with the flow control device in a midrange flow position,

FIG. 4 is an enlarged view of the circled portion of FIG. 1 with the flow control device in a shutoff flow position,

FIGS. 5 and 6 illustrate alternative embodiments for a seal element,

FIG. 7 is an alternative embodiment of a flow control device,

FIGS. 8-13 are exemplary illustrations of alternative patterns of flow openings and the associated flow profile comparing flow rate with relative axial position of the flow element,

FIGS. 14 and 15 illustrate an alternative embodiment for a seal element.

### SUMMARY OF EXEMPLARY EMBODIMENTS OF THE INVENTIONS

A first inventive concept presented herein provides a flow control device with a variant orifice or flow opening to allow an adjustable flow rate. In an embodiment, the flow control device includes a seal element and a flow element that in a first position presents a first flow area and in a second position presents a second flow area. Additional embodiments of this concept are presented herein.

A second concept presented herein provides a flow element with a variant orifice for a flow control device. In an embodiment, the flow element may have a hollow body and at least one flow opening in a wall of the hollow body. In another embodiment, the at least one flow opening may have a first flow area at a first position relative to a reference axis and a second flow area at a second position relative to the reference axis. Additional embodiments of this concept are presented herein.

A third concept presented herein provides a seal element with a segmented geometry. In an embodiment, the seal element includes a first portion, a second portion, and a transition portion that joins the first portion and the second portion. The transition portion isolates the second portion from stresses applied to the first portion. In another embodiment, the first portion has an outside diameter, the second portion has an outside diameter, with the first portion outside diameter being greater than the second portion outside diameter. The seal element may, in an embodiment, be part of a flow control device as set forth herein.

The concepts may be used for liquid or gas delivery, although the concepts are well suited for fluid metering applications.

### DESCRIPTION OF THE EXEMPLARY EMBODIMENTS

With reference to the drawings, in an exemplary embodiment, a flow control device 10 may be realized in the form of a valve and actuator assembly 10. The valve and actuator assembly 10 may include an actuator assembly 12 and a valve assembly 14. The actuator assembly 12 may be stacked on top of the valve assembly 14 or otherwise operably coupled therewith. The actuator assembly 12 preferably is of the type that imparts or causes linear movement with respect to a reference axis. Although this exemplary embodiment illustrates use of a manual actuator, alternative embodiments may use other types of actuators, for example, an automatic actuator such as an electromagnetic actuator to name one example. By automatic actuator is meant an actuator that is operable other than by force being applied manually to a handle or other manually driven device. The use of an automatic actuator also facilitates the ability to utilize remote actuation over a wired or wireless network.

The valve assembly 14 is an embodiment of a flow control device 10 as set forth herein; but the teachings herein may alternatively be used with other flow control device designs and configurations other than a bellows-type valve as disclosed herein. For example, alternatively the valve assembly may be a diaphragm valve or other valve design that operates in response to linear actuation.

A reference axis X is noted on the figures. All references herein to axial or radial positions and movement are with respect to the reference axis X unless otherwise noted. The reference axis X, also referred to herein as the axis X, may be but need not be coaxial with the central longitudinal axis of the bellows stem (34.)

The actuator assembly 12 and most of the valve assembly 14 may conveniently be designed to form a modified BM series bellows-sealed metering valve which is available commercially from Swagelok® Company, Solon, Ohio. The BM Series is also shown in the product catalog titled BELLOWS-SEALED METERING VALVES which is available on-line at Swagelok.com and is fully incorporated herein by reference. However, many other actuator designs and valve designs may alternatively be used. The teachings herein are not limited to use with a bellows-sealed valve assembly, but may alternatively be used with many other valve designs, including but not limited to a tied diaphragm valve or a valve having a stem sealed by o-rings or packings such as may be used in traditional needle valves or plug valves and so on.

The actuator assembly 12 for convenience may be but need not be the same as a manual actuator assembly that is sold commercially with the BM Series bellows-sealed valves. Therefore, a detailed explanation of the actuator assembly 12 is not necessary to understand and practice the present teachings. However, alternatively many different types of actuators may be used as needed for particular applications and requirements.

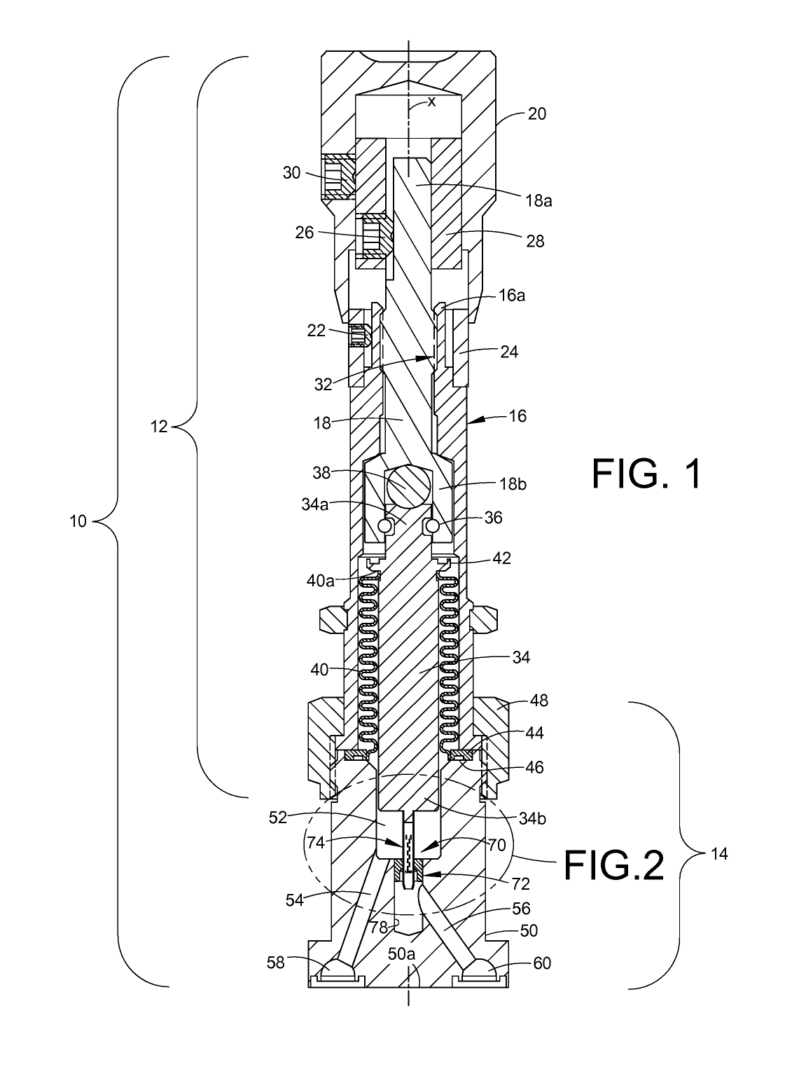

The actuator assembly 12 embodiment includes a bonnet 16 with an actuator stem 18 slideably disposed therein. The actuator stem 18 is operably coupled to a manually actuated handle 20 at a first or proximal end 18a of the actuator stem 18. A first set screw 22 may be used mechanically to couple a barrel 24 to an upper end 16a of the bonnet 16; a second set screw 26 may be used mechanically to couple an upper end 18a of the actuator stem 18 to a bushing 28; and a third set screw 30 may be used mechanically to couple the handle 20 to the bushing 28. A threaded connection 32 is used between the actuator stem 18 and the bonnet 16. As such, clockwise and counter-clockwise rotation of the handle 20 about the axis X translates or axially moves the actuator stem 18 down and up as viewed in FIG. 1 for a conventional right-hand threaded connection 32. Alternatively, non-threaded mechanical connections to an actuator stem may be used with actuators, for example, that impart linear movement to the actuator stem other than by rotation of a threaded connection.

At a second or distal end 18b of the actuator stem, the actuator stem 18 is operably coupled to a bellows stem 34 at a first or proximal end 34a thereof such as with a snap ring 36, for example, and a bearing 38. The bearing 38 allows for free and low friction rotation between the actuator stem 18 and the bellows stem 34 while at the same time mechanically coupling these parts together so that axial translation of the actuator stem 18 produces corresponding axial translation of the bellows stem 34. A bellows 40 is welded at a first end 40a to a shoulder 42 on the bellows stem 34. A second or opposite end 40b of the bellows 40 is welded to a weld ring 44. The weld ring 44 may be welded to the valve body to form a fluid tight body seal, or alternatively a gasket 46 may be used to form a fluid tight compression body seal. A bonnet nut 48 is used mechanically to couple the bonnet 16 to the valve assembly 14, for example, with a threaded connection.

The valve assembly 14 embodiment for convenience may be but need not be a modified version of a valve assembly that is sold commercially as part of the BM Series bellows-sealed valves. The BM series valve includes a flow control device body 50 (also referred to herein as a valve body) that has a flow chamber 52 that receives a lower or distal end 34b of the bellows stem. An inlet 54 and an outlet 56 communicate with the flow chamber 52 as further described below. This portion of the valve assembly 14 may be but need not be the same as the BM Series valve. Note that the valve body configuration illustrated in the drawings is for a surface mount configuration in which a first or inlet valve port 58 and a second or outlet valve port 60 are formed in a lower surface 50a of the valve body 50. Flow may be reversed through the valve assembly 14, however, in which case the inlet to the flow chamber 52 would be at 56 and the outlet from the valve chamber would be at 54. Other valve body configurations and valve porting configurations besides surface mount may be used, for example, with traditional end connections for flow through valves, right angle valves, three way ported valves and so on.

Although reference is made herein to an inlet 54 and an outlet 56 and a flow chamber 52, this is simply for convenience in describing the apparatus in valve related terminology. The inlet and outlet are in a broader sense portions of a flow path (FP) that in part includes a first portion 54 and a second portion 56. Flow along the flow path may be in either direction so that either the first portion 54 or the second portion 56 may serve as an inlet or upstream flow portion, while the other portion may serve as the outlet or downstream flow portion. For flow control, a flow control arrangement, for example, a valve mechanism or a metering mechanism may be disposed between the first portion 54 and the second portion 56 as described further below.

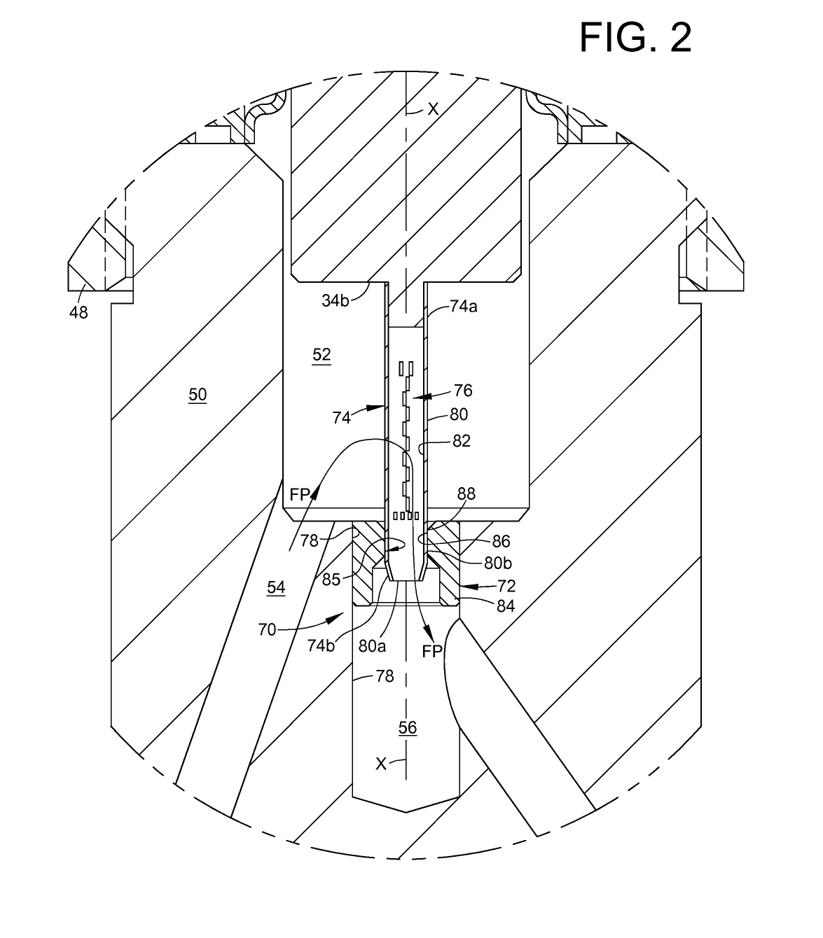

In an embodiment of the present teachings, disposed between the inlet 54 and the outlet 56 is a flow control arrangement 70. The flow control arrangement 70 may include a seal element 72 and a flow element 74 (see FIG. 2) that cooperate to provide a seal interface therebetween. The flow control arrangement 70 replaces the fixed orifice and stem tip of a traditional BM Series valve. The flow element 74 may be realized in many different ways, with a fundamental feature being that the flow element 74 provides part of the fluid flow path (FP in the various views) between the flow path first portion 54 (the inlet in the embodiments herein) and the flow path second portion 56 (the outlet 56 in the embodiments herein), as a function of the relative position of the flow element 74 with respect to the seal element 72. The flow element 74 includes one or more flow openings 76 through which fluid communication is provided between the inlet 54 and the outlet 56. The seal element 72 cooperates with the flow element 74 in order to control flow through the flow element 74 as a function of the relative position of the flow element 74 with respect to the seal element 72. The flow element 74 and the seal element 72 may take on many different forms including geometry, patterns of the flow openings, materials and so on as set forth in additional exemplary embodiments herein.

In a further embodiment, the relative position between the flow element 74 and the seal element 72 may be a relative axial position with respect to the reference axis X, as an example. The seal element 72 in an embodiment may be fixed in position relative to the flow element 74. For example, the seal element 72 may be press fit or otherwise secured in position in a valve body bore 78 that in part defines the outlet 56 from the flow chamber 52. Many alternative techniques may be used to fix the seal element 72 in position relative to the flow element 74.

A proximal end 74a of the flow element 74 may be attached to the distal end 34b of the bellows stem 34. For example, a press fit, weld, adhesive or any other convenient mechanical coupling or attachment means may be used to connect the bellows stem 34 and the flow element 74. Accordingly, axial translation of the bellows stem 34 by operation of the actuator assembly 12 will produce axial translation of the flow element 74 relative to the seal element 72. Although axial linear translation of the flow element 74 is preferred, this does not restrict the many different ways that axial linear translation can be effected, including but not limited to the use of actuation mechanisms and mechanical couplings that convert rotary or other motion into linear displacement.

It will be noted that in an embodiment with a bellows, the maximum stroke of the bellows stem 34 determines the maximum stroke of the flow element 74; and the sensitivity or control of the stroke of the bellows stem 34 and the flow element 74 is determined by the mechanical coupling between the actuator assembly 12 and the bellows stem 34. For example, fine control may be realized with fine thread pitch at the mechanical threaded connection 32 to produce a fine axial stroke of the flow element 74 relative to degrees of rotation of the handle 20, whereas a course thread pitch will produce a course axial stroke of the flow element 74 relative to degrees of rotation of the handle 20.

In alternative embodiments, the flow element 74 may be the fixed member and the seal element 72 may be the movable member that translates axially by operation of the actuator assembly 12.

The flow element 74 may take on many different shapes and configurations depending on the flow profile that is desired. By flow profile is meant the flow rate versus axial stroke or displacement of the movable member, such as for example, the flow element 74. The desired flow profile will depend on the particular application or end use for the valve assembly 14 and can easily be implemented by appropriate selection and location and geometry of the flow openings 76. A distinct advantage realized with the present teachings is that the flow profile can be changed by simply replacing the flow element 74 having the desired pattern of flow openings 76, so that the same valve body 50, seal element 72 and even the same actuator assembly 72 if so desired can be used. This can greatly reduce inventory and changeover time by not having to replace the entire assembly 10 just to change the flow profile.

FIGS. 2-4 illustrate an embodiment of the flow element 74 and flow openings 76 in which the flow openings are generally arranged along the reference axis X. The flow element 74 may be a tubular or hollow cylindrical body 80 with an optional open distal end 80a. The flow openings 76 may be formed as orifices through a cylindrical wall 82 of the tubular body 80. The shape, size, number and position of the flow openings 76 will determine how the flow changes in relation to the axial position of the flow element 74 relative to the seal element 72, and therefore the combination of all the flow openings together provide a variant orifice. The tubular body 80 may be made of any material that is suited to the application, including metal such as stainless steel or alternatively other metals, non-metals, polymers and so on as needed. The flow openings may have many different shapes and geometries including but not limited to slots, circular, oval or elliptical, curved, straight and so on.

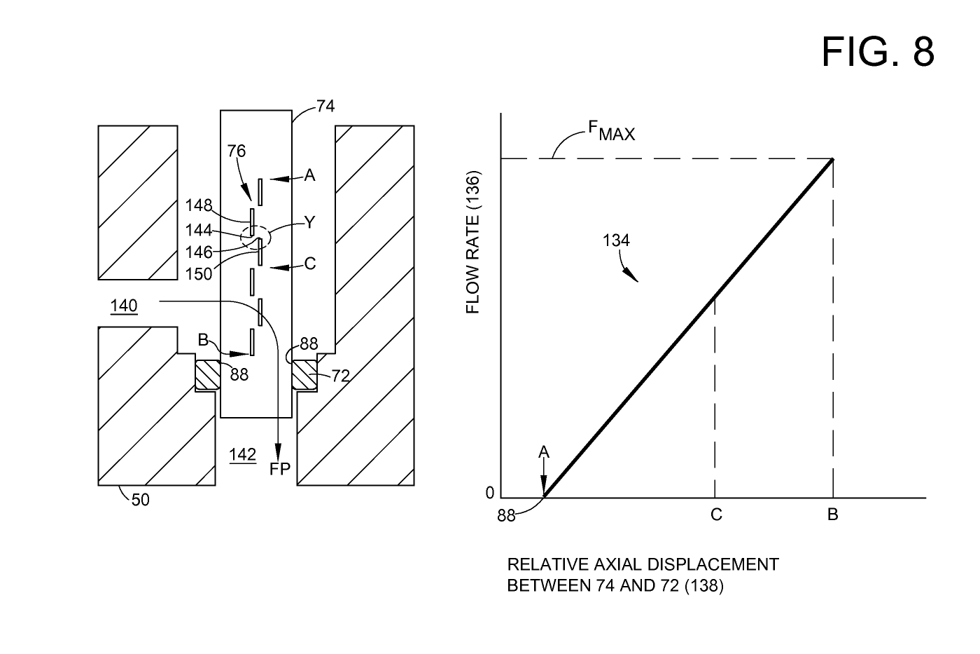

The seal element 72 may also take on many different shapes, sizes, material, geometry and so on. In FIGS. 2-4 the seal element 72 may be realized in the form of an annular sleeve or ring 84 having an internal through bore 85 that presents a seal surface 86 that contacts and seals against a seal portion of the outer surface 80b of the tubular body 80. The location of the seal portion along the outer surface 80b is a function of the axial position of the flow element 74 relative to the seal element 72 as further explained hereinbelow. Although the seal surface 86 has an axial length over which a seal is formed with the outer surface 80b of the tubular body 80, the end portion or leading edge of the seal surface 86 serves as a reference point (see reference 88 in FIGS. 8-13 and the related discussion, for example) where flow through the flow openings 76 is either open or closed off. The location of the reference point 88 for control of flow through the flow openings 76 will depend on the specific implementation of the flow element 74 and the seal element 72 which as noted may take on a wide variety of embodiments.

The seal element 72 may be an embodiment of a hard seal, such as being composed of a metal, to form a metal to metal seal with the tubular body 80, or the seal element 72 alternatively may be a hard non-metal such as ruby; further still the seal element 72 alternatively may be a soft seal such as a polymer or rubber that provides a snug fit with the tubular body 80. Exemplary materials for the seal element 72 include but are not limited to plastics such as PFA (perfluoalkoxy), PTFE, (polytetrafluoroethylene), PCTFE (polychlorotrifluoroethylene), PEEK (polyetheretherkeytone), PI (polyimide), elastomers, rubber and metals such as 316 stainless steel, ceramics and so on to name a few. In addition, the use of coatings or surface treatments on the seal element 72 portion that contacts the flow element 74 and/or the outer surface of the flow element 74 itself may be included as a means to enhance durability and seal performance. For example, stainless steel surfaces may be surface treated with low temperature carburization processes. Surface coatings may alternatively be used, for example, titanium nitride, ceramic coatings, lubricious coatings for example PTFE, diamond like carbon coating, and so on to name a few examples. The seal element 72 may alternatively be a composite structure, for example, a metal ring with a polymer or other soft material at the seal surface, or a hard non-metal insert such as ruby or a ceramic and so on. Although the exemplary embodiments include all metal parts, for example, stainless steel such as 316 stainless steel for the tubular body 80 and metal for the seal element 72, non-metal flow control devices 10 may be used, for example, made of polymers or other non-metal materials. Metal materials may be preferred in various applications for temperature related stability of the flow profile.

Although the element 72 is referred to as a seal element, those skilled in the art will understand that the seal element 72 cooperates with the flow element 74 to control fluid flow along the flow path FP. As with any dynamic seal and some static seals, there may be but need not be in all situations some fluid leakage or by-pass flow between the seal element 72 and the flow element 74. The seal interface between the seal element 72 and the flow element 74 in the exemplary embodiments herein is a dynamic seal meaning that the seal is maintained in the annulus between the tubular body 80 and the inside surface of the seal element 72 which move or slide relative to each other. When there is relative axial displacement or movement between the seal element 72 and the flow element 74, the seal interface therebetween is a dynamic seal. When the seal element 72 and the flow element 74 are stationary relative to each other, the seal interface therebetween is a static seal. Particularly for metal to metal seals, there may be leakage or by-pass flow, but the seal element 72 is intended to inhibit such leakage or by-pass flow to an acceptable amount for particular applications, relative to the overall flow FP, by having a tight tolerance between the outside diameter of the flow element 74 and the inside diameter of the seal element 72. In general, and particularly for low flow rates, the seal between the seal element 72 and the flow element 74 reduces or minimizes by-pass flow or leakage so that such leakage will not adversely affect the desired flow profile. In lower pressure applications there may be no leakage or by-pass flow depending on the tolerances allowed for the seal element 72/flow element 74 interface.

Although in FIGS. 1-4 the flow element 74 and the seal element 72 are each a one-piece unitary part, such is not required, and either or both may be constructed of multiple parts, with some examples presented hereinbelow. Also, it is preferred but not always required that the seal element 72 be formed as a one-piece body, for example the hollow cylindrical body 80, and it is also preferred but not always required that there be no ports, orifices or other openings through the interior seal surface 86 so that flow from the flow element 74 through the seal element 72 is axial.

In FIG. 2, the actuator assembly 12 has been retracted upward as viewed in the drawing so that the flow control arrangement 70 is in a full flow, fully open position. The distal end or leading edge portion 88 of the seal element 72 that first makes sealing contact with the flow element 74 may serve as a reference point or reference location along the reference axis X of where the flow openings 76 either become partially or fully open or obstructed by the seal element 72 so that the total exposed flow area and resultant flow rate changes with relative axial position of the flow element 74 with respect to the seal element 72. For example, flow is shutoff where the flow element 74 is in a fully extended position (downward as viewed in the drawings) so that all of the flow openings 76 become isolated from the upstream side of flow. Flow begins as the flow element 74 is axially translated or extended (upward as viewed in the drawings) so as to expose partially or fully one or more of the flow openings 72 to the upstream side of flow. The amount of contact area between the seal element 72 and the flow element 74 can be selected as needed based on various factors including fluid pressure and the characteristics of the fluid being contained by the valve assembly 14. In an idealized sense, the leading edge portion 88 will seal against the flow element 74 and serve as an axial reference location where the amount of surface area exposed to the upstream flow changes with axial displacement of the flow element 74 with respect to the seal element 72.

In the position of FIG. 2, a flow path FP is provided from the inlet 54, through the flow openings 76, through the tubular body 80 and into the outlet 56. With all of the flow openings 76 being in fluid communication with the inlet 54, maximum flow will be provided. The flow capacity will be a function of the total flow area presented by the flow openings 76 that are—at any given axial position of the flow element 74 relative to the seal element 72—in fluid communication with the inlet 54. Note that various flow openings 76 may present a flow area that is only partially in fluid communication with the inlet 54 depending on the relative axial position of the flow element 74 with respect to the seal element 72. This feature contributes to the availability for very precise flow control even at very low and very high flow rates as well as facilitates design of the flow element 74 to produce different flow profiles. The flow openings 76 are geometrically stable and the seal element 72 may act as a bearing to journal the flow element 74 so that even at very low or high flow rates the flow characteristics of the fluid are stable.

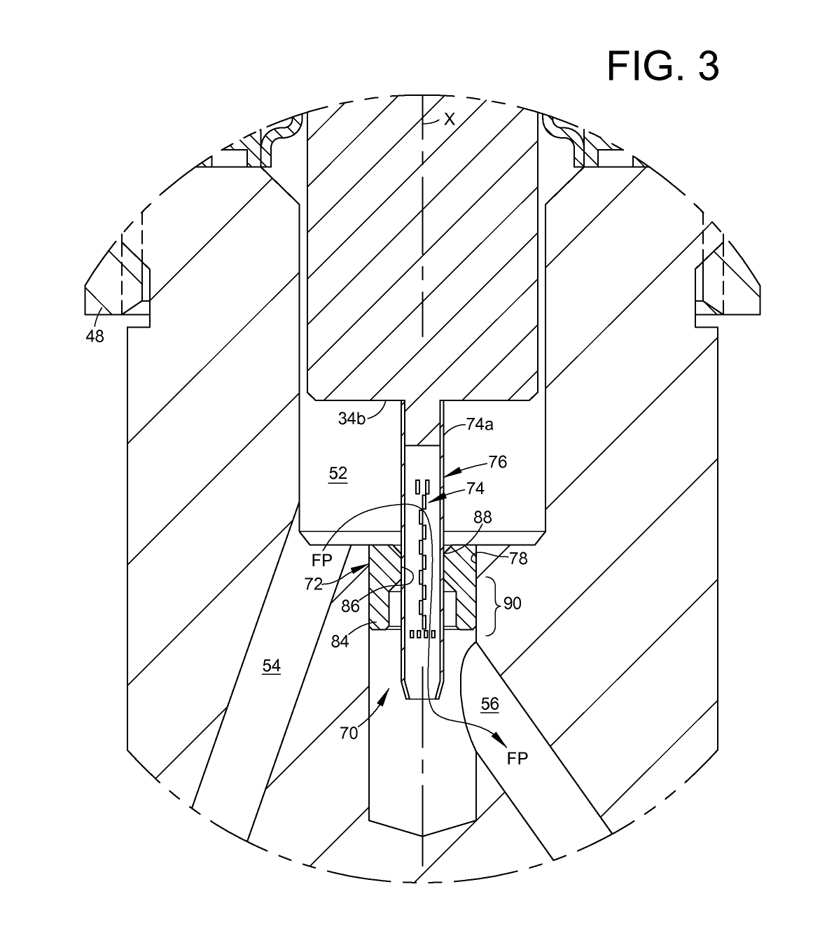

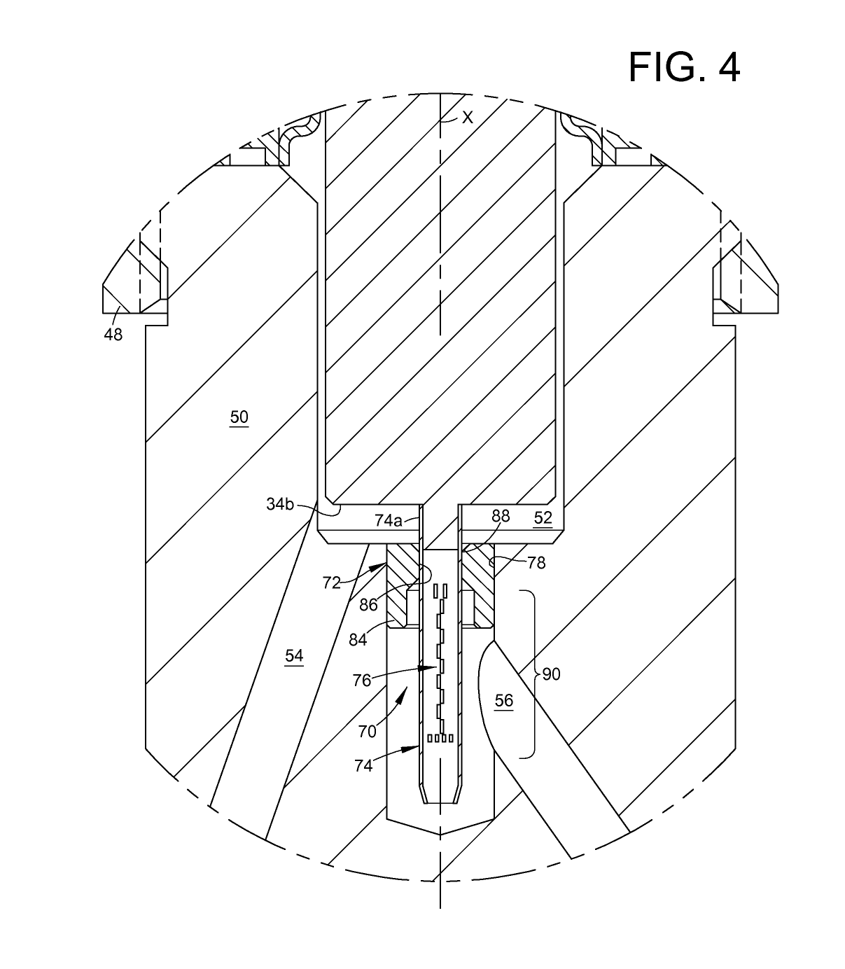

In the position of FIG. 3, the flow element 74 has been extended axially further through the seal element 72 so that more of the flow area of the flow openings 76 (approximately labeled 90 in FIG. 3) are axially past the leading edge portion or reference location 88 and, therefore, are sealed from fluid communication with the inlet 54. Thus, this position may be thought of as a midrange position in which the flow rate can be set to a value between the maximum flow rate of FIG. 2 to a minimum or shutoff flow rate (FIG. 4).

In the position of FIG. 4, the flow element 74 is fully extended axially so that all of flow openings 76 are axially past the reference location 88 and no longer in fluid communication with the inlet 54. This may be thought of as a shutoff position because the entire flow area of the flow openings 76 are sealed from fluid communication with the inlet 54. Note that a true zero flow shutoff can be achieved, which is a distinct improvement over needle style metering valves that are difficult to fully shutoff.

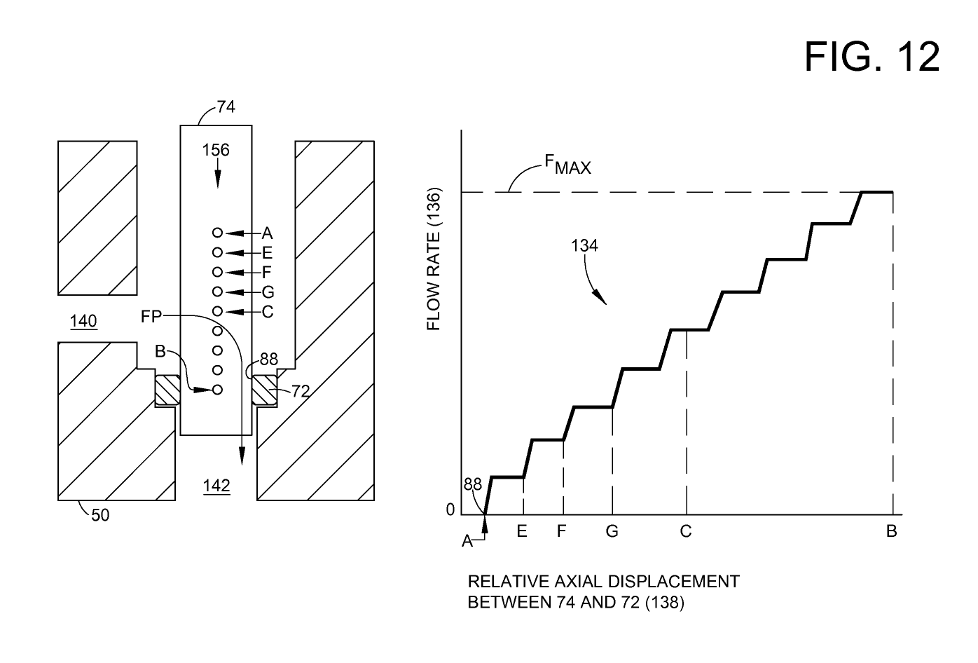

In an embodiment, the flow element 74 may be realized using a ¼inch piece of tubing such as stainless steel tubing. Using the teachings herein, very precise control of the flow may be achieved to as low as approximately 0.01 Cᵥ for full flow or more, even greater than 1 Cᵥ. Using the teachings herein even 0.0001 Cᵥ full scale flow can be achieved. Fine or course resolution may be realized as needed for particular applications. For example, a fine resolution using a “digital” pattern of flow opening 76 (see, for example, FIG. 12 herein) may be used to achieve incremental resolutions as fine as 0.00001 Cᵥ, while an analog pattern of flow openings 76 may be used to achieve resolutions of below 0.005 Cᵥ. The resolution achieved is also a function of the accuracy and resolution of the actuator assembly 12.

The flow openings 76 may be used in many embodiments in the form of slots or openings through the wall of a tubular flow element as noted above. This allows the use of a thin wall tubular body 80 with a geometrically stable flow area because the various flow openings 76 are geometrically stable, thereby providing a stable flow area as the variant orifice.

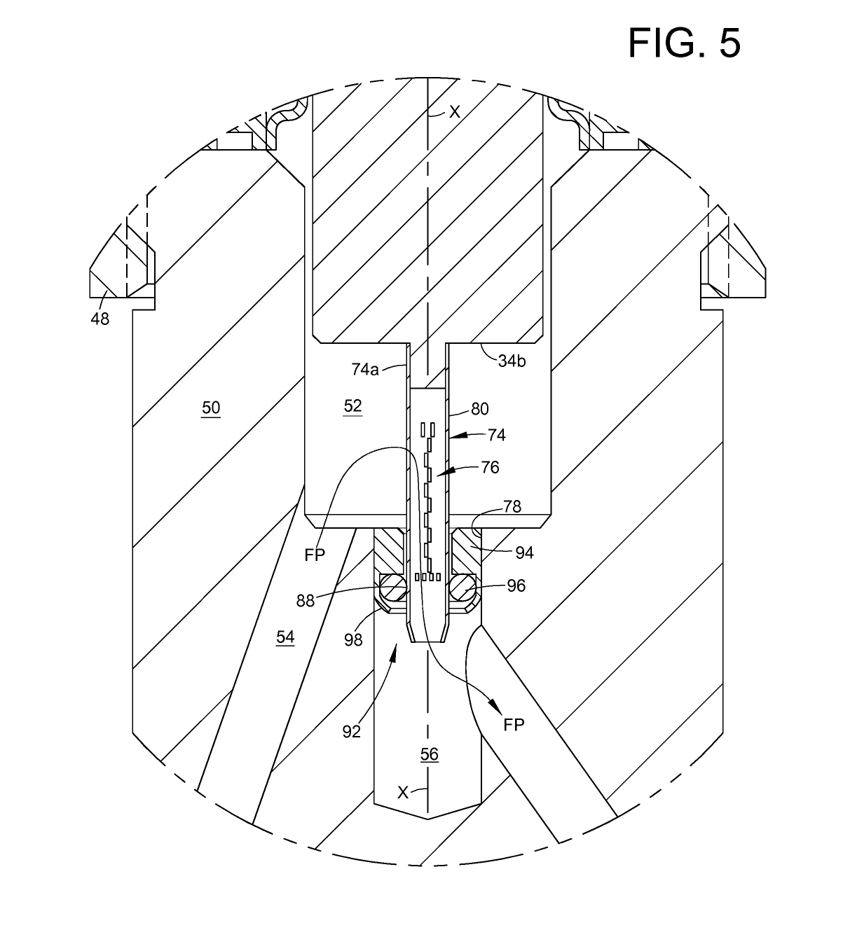

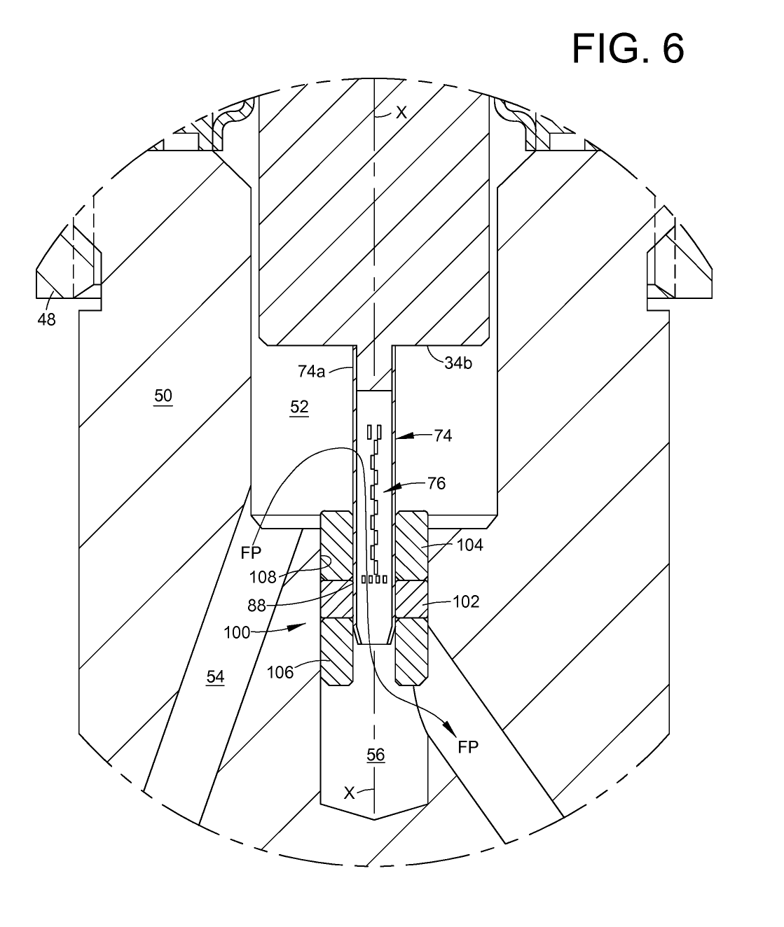

FIGS. 5 and 6 illustrate a few of the many alternative embodiments for providing the seal element 72. In these embodiments, the various other components such as the flow element 74, the bellow stem 34 and the valve body 50 may be but need not be the same as the embodiment of FIGS. 1-4. In FIG. 5, a seal element 92 is provided as a two piece assembly including a seal holder 94 and a seal member 96. This is an embodiment of a soft seal element, for example, an elastomer seal member or a plastic or other non-metal seal member, for example, an o-ring as shown in FIG. 5. The seal holder 94 may include a distal end 98 that is staked inward to retain the seal member 96. The seal member 96 may be sized as needed to form a compression seal against the outside surface 80b of the flow element tubular body 80. Note that the seal holder 94 does not need to make metal to metal contact with the flow element

In FIG. 6, a seal element 100 may be a three piece assembly including a soft non-metal seal member 102 may be axially dispose between a first seal retainer 104 and a second seal retainer 106. The seal retainers 102, 104 may, for example, be press fit into a bore 108 in the valve body 50.

In the embodiments described thus far, the flow element is movable under the control of the actuator assembly 12 while the seal element is fixed in position relative to the flow element. Alternatively, the flow element may be fixed in position relative to the seal element with the seal element being movable under control of the actuator assembly 12. In either case, flow is changed by relative axial displacement between the flow element and the seal element.

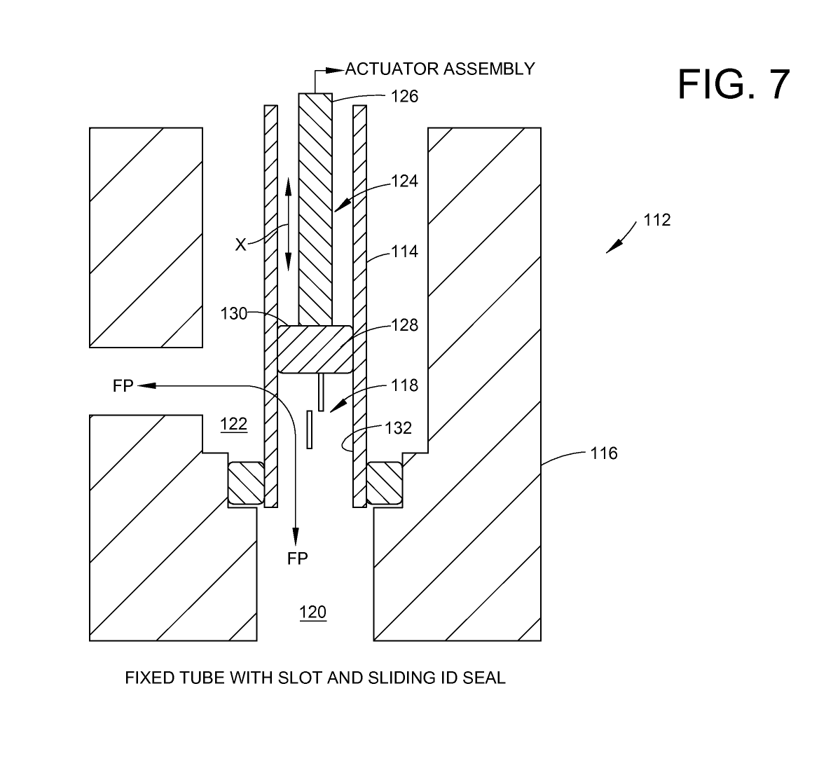

FIG. 7 illustrates an alternative embodiment in which the seal element may be the movable part. FIG. 7 is a simplified schematic illustration of a flow control device 112. In an embodiment, a flow element 114 is fixed in position in a valve body 116. The flow element 114 may be a hollow tubular member and have one or more flow openings 118 that admit fluid flow between a first flow path (FP) portion 120 and a second flow path portion 122. The direction of flow may be in either direction as in the above embodiments. Note that the flow element 114 may have more flow openings 118 than are illustrated in FIG. 7. A movable seal element 124 is disposed within the flow element 114 and has a proximal end 126 that would be operably coupled to an actuator assembly (not shown) so that the seal element 124 can be axially translated relative to the flow element 114 with respect to a reference axis X. The seal element 124 may include a seal member 128 at a distal end 130 or otherwise positioned on the seal element 124. The seal member 128 seals against an inner surface 132 of the flow element 114, and the axial position of the seal element 124 relative to the flow element 114 determines the flow area of the flow openings 118 that are open to admit fluid flow.

FIGS. 8-13 present alternative patterns for the flow openings 76 and the resultant flow profile 134 as illustrated in associated graph. Each drawing shows a flow element 74 with an associated pattern of flow openings 76; and the adjacent graph illustrates the flow profile. Note that the slope of the flow profile indicates the rate of change of the flow rate as a function of relative axial displacement of the flow element 74 and the seal element 72. The flow profiles 134 are presented as a graph of flow rate 136 versus axial displacement 138, where axial displacement refers to the relative axial movement or stroke of the flow element 74 with respect to the seal element 72. In an idealized case the axial displacement 138 is relative to the seal element 72 and more particularly to the reference location 88 that provides a relative axial position of the flow element 74 with respect to the seal element 72 to open or obstruct flow area of the flow openings 76 with respect to the upstream flow portion 54. Therefore, starting from an initial position that is a full flow position, flow along the flow path FP begins when point A of the flow element 74 is displaced upwardly (as viewed in the drawings) past the reference location 88; and the flow rate increases to a maximum (F_{MAX}) at point B when all of the flow openings 76 and flow area are fully exposed to the upstream flow portion 140. Accordingly, flow shutoff occurs when the flow element 74 is axially displaced to a position at which point A is past the reference location 88 (fully downward stroke as viewed in the drawings) such that all the flow openings 76 and flow area are fully isolated from the upstream flow portion 140. Midrange flow is approximately noted at C. The initial flow at location A may be zero as illustrated, or alternatively and depending on the shapes of the flow openings 76 and also whether the actuator operates with fine or course control of the axial stroke, flow rate may initially jump or step from zero to an initial flow rate well above zero.

Note that in the circled portion Y of FIG. 8 and various other figures that in order to provide a smooth flow transition as more of the flow openings 76 move into fluid communication with the upstream portion 54, the flow openings may be spaced apart radially but from an axial point of view partially overlap or at least axially coincide at axially adjacent ends 144, 146. This overlap provides smoother transition in flow as one flow opening 148 (which in an embodiment are in the form of elongated slots) becomes fully open to the upstream portion 140 and the next axially positioned flow opening 150 begins to open to the upstream portion 140. The flow profile in FIG. 8 is approximately linear because of the axially evenly spaced flow openings 76 having approximately equal flow areas with each other. The flow openings 76 may be precisely made by laser processing techniques or other available machining processes, however, the level of precision used may be determined by how accurate the metering or flow control function needs to be for particular end uses in response to operation of the actuator 12. Therefore reference is made to “approximate” flow rates and profiles as they can vary from highly precise and accurate for precision applications to less precise for applications needing less accuracy in flow rate control as a function of the actuator 12 operation.

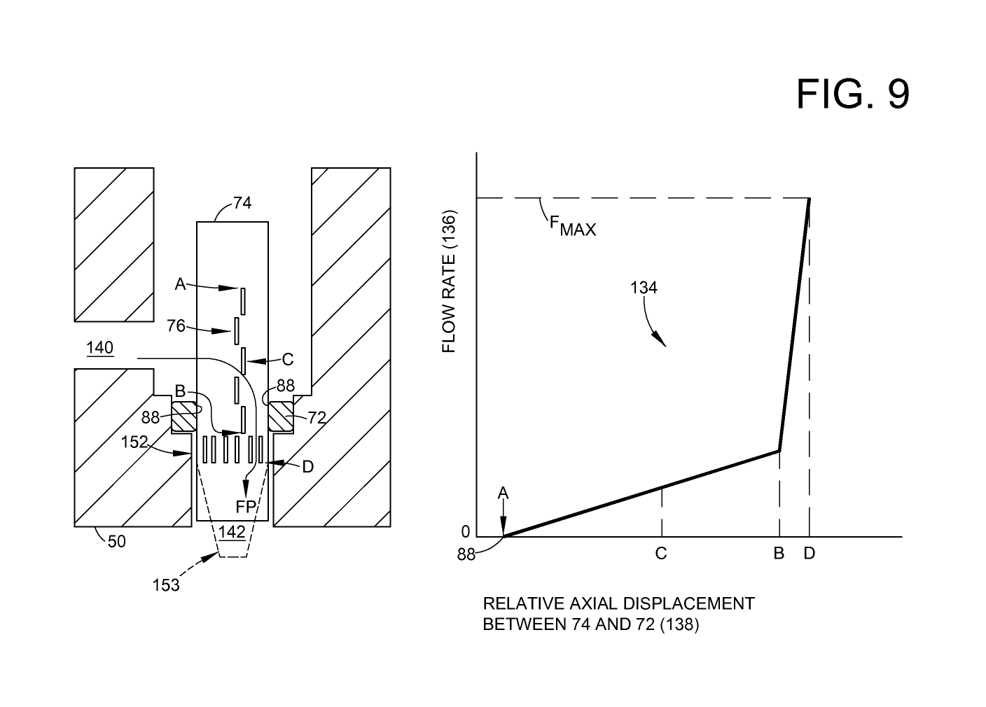

FIG. 9 is similar to FIG. 8 but at one end of the flow openings a higher flow area may be provided using for example, a higher number or density of flow openings 152. This produces a higher flow rate and rate of change of the flow rate (as indicated by the change in slope of the rate profile at point B in the graph). This may be used, for example, as a purge flow position. FIG. 9 is also a similar basic embodiment as used in FIGS. 1-6.

FIG. 9 also illustrates an alternative embodiment to use of the higher density of flow openings 152. The flow element 74 may be tapered or otherwise shaped with a reduce outside diameter as illustrated in phantom. For example, the flow element 74 may be provided with a conical surface or frusto-conical geometry 153 so that when the flow element 74 is fully withdrawn upwards (as viewed in the drawing) to reach maximum flow through the flow openings 152, the flow rate after axial position B relative to the seal element 72 reference location 88 will rapidly increase to in effect provide a purge flow. This increase in flow rate is due to the tapered geometry 153 allowing rapidly higher flow rate as the internal through bore 85 (FIG. 2) of the seal element 72 becomes unobstructed. The flow curve then may be but need not be similar to the graph in the FIG. 9 curve but the higher density flow openings 152 may be omitted. Note that the taper or reduced diameter geometry may also be used at the upper end of the flow element (as viewed in the drawings) to provide an increased flow rate such as a purge before the valve is fully closed. The taper or reduced diameter geometry may be also used at any axial position along the flow element 74 as needed to produce a high flow rate. Also, the inverse may be provided, for example, where the diameter of the flow element 74 may be enlarged at a desired location to choke off or reduce flow rate as needed for particular applications.

Note that in the various embodiments herein, the flow element 74 may include an end taper 74b (FIG. 2) that may be, for example, a frusto-conical geometry of the hollow cylindrical body 80. This axially short taper 74b may be used to improve ease of insertion of the flow element 74 into the seal element 72.

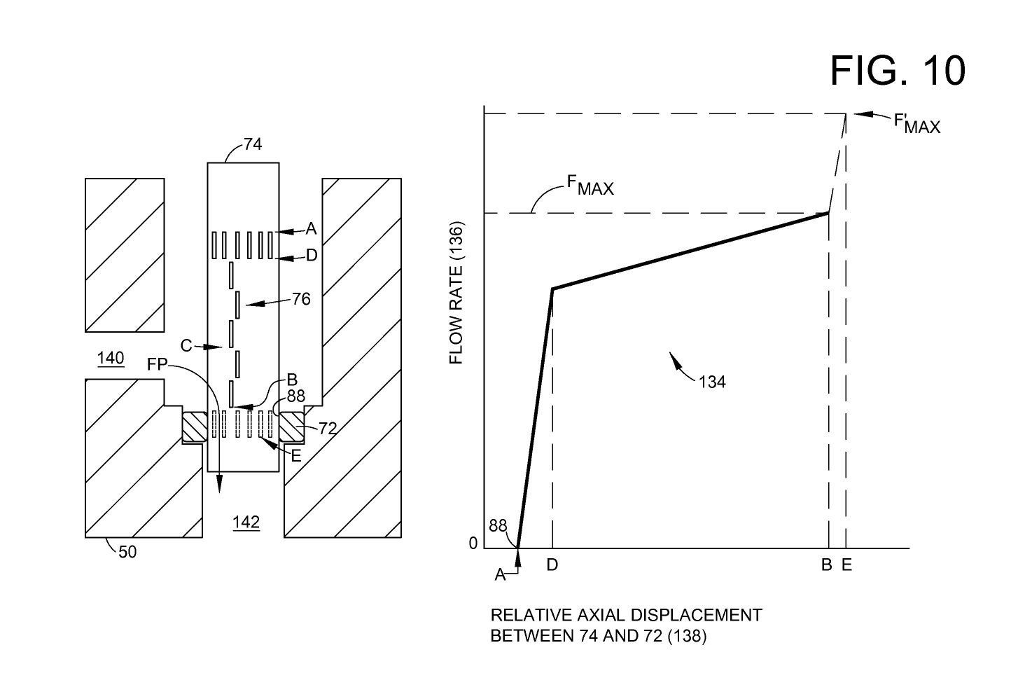

FIG. 10 is the inverse of FIG. 9 in the sense that the higher flow rate (for example a purge flow) is positioned where flow begins. This may be used for example as a purge at opening. Alternatively, FIGS. 9 and 10 could be used to provide a purge operation at the beginning of flow and at the maximum flow position (as shown by the dashed lines in FIG. 10) to produce a maximum purge F′_{MAX}.

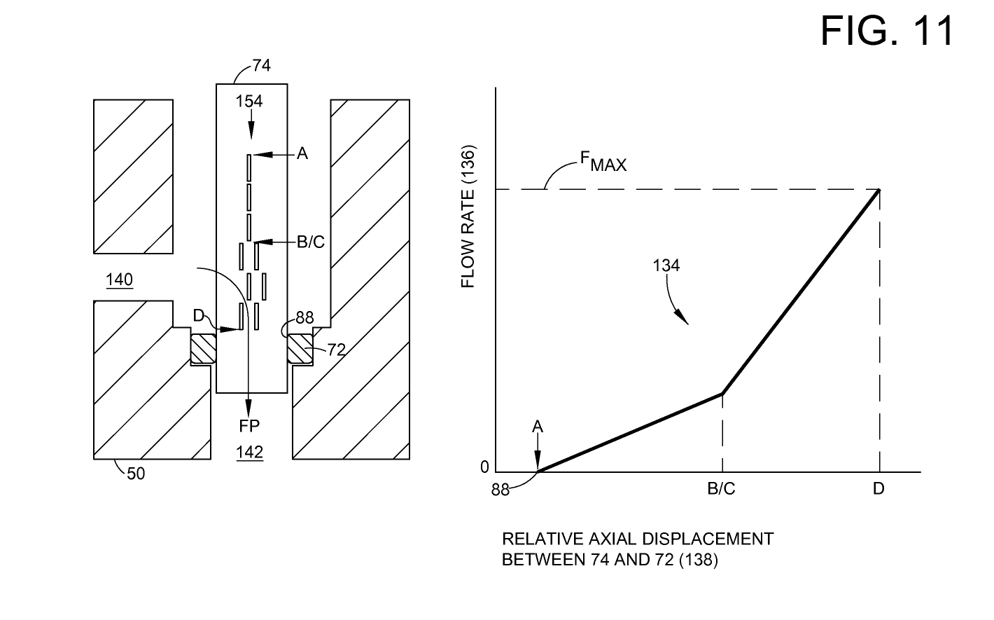

FIG. 11 illustrates using different numbers or density of flow openings 154 axially along the flow element 74 to produce different rates of change of the flow rate, as represented by the change in slopes of the flow rate curve portions. This is a variation of the purge feature as shown in FIGS. 9 and 10. In an embodiment, the change in slope occurs about at the midrange of flow.

FIG. 12 illustrates an example wherein the flow openings 156 are discrete and separate from one another (with lands in between) so as to provide a “digital” type flow profile, such as may produce a step-wise response. In an embodiment, the flow openings 156 may be round openings. Note that the slope between the steps will be a function of the axial length of the round openings 156. The slope may be changed, for example, using elliptical or oval openings.

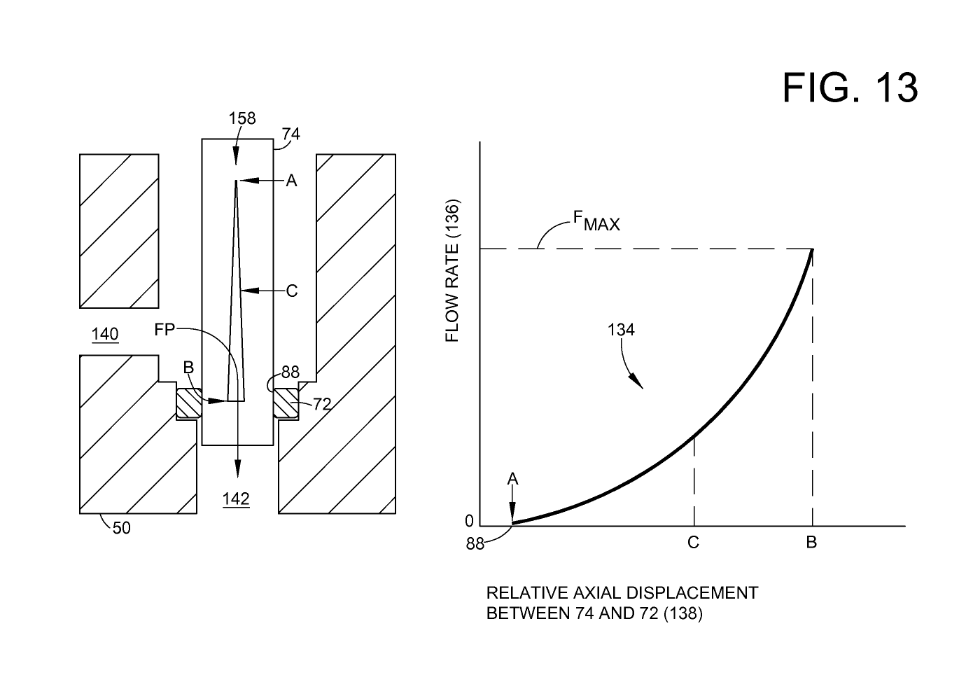

FIG. 13 illustrates an example of a single continuous flow opening 158 that may be tapered for example to give a continuously varying rate of change of the flow rate 136. The shape and orientation of the tapered slot 158 may be changed to accommodate other flow profiles. As an example, the single continuous flow opening 158 could be a slot of constant width (not tapered) which would produce a linear rate of change of the flow rate 136. In an embodiment where the single slot is simply a longitudinally split tubular member with an end to end lengthwise opening or split, the tubular member may need hoop support or be made of a heavier (thicker) wall so that the dimensions of the slot remain stable.

FIGS. 8-13 are intended to be exemplary. The shape, density, distribution and so on of the flow openings may be chosen to derive many different flow profiles.

In an alternative embodiment, rather than using formed flow openings 76 in a flow element 74, the flow element 74 may be made of a porous material. For example, the flow element 74 may be made of a sintered stainless steel having a porosity that is a function of the size of the pores in the sintered material. These pores can then serve as flow openings to provide a flow path through the wall of the hollow flow element 74.

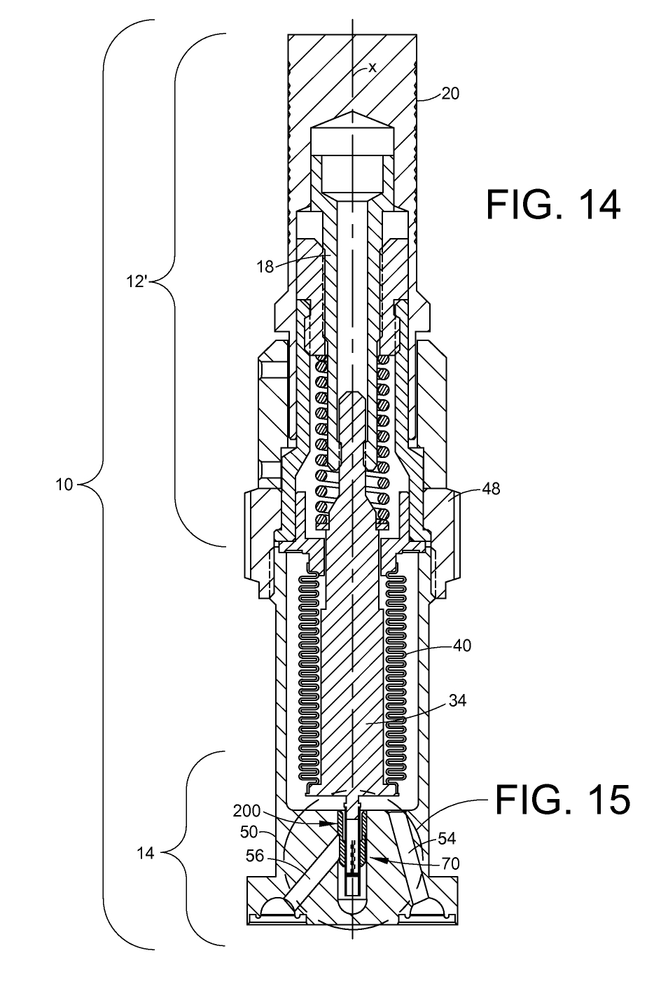

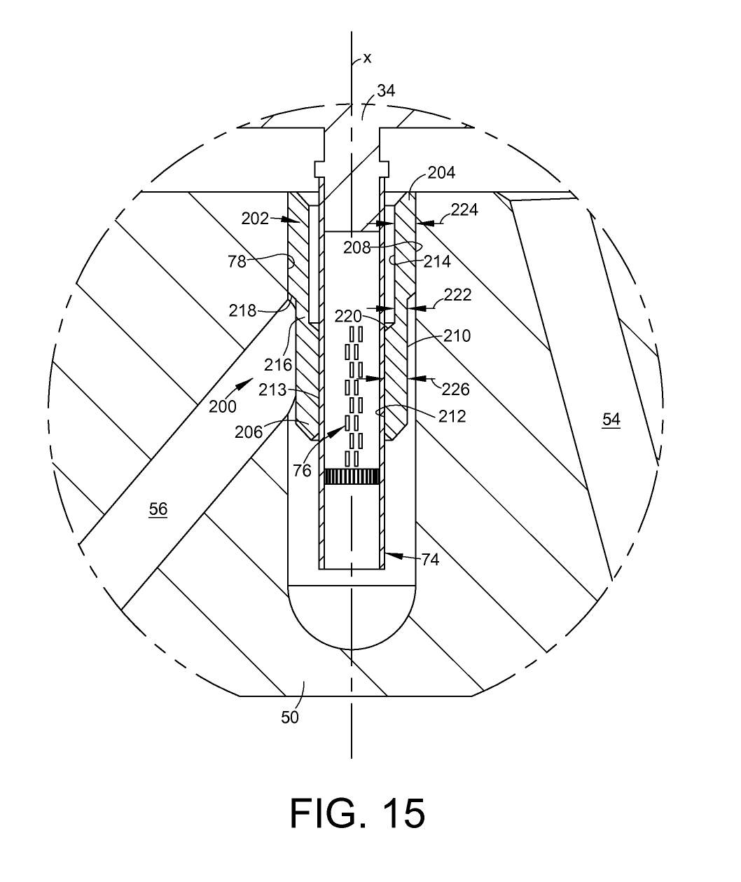

FIGS. 14 and 15 illustrate an alternative embodiment for a seal element 200 that may be used for the seal element 72 previously described herein. All other aspects and features of the exemplary embodiments may be but need not be used with this alternative seal element, accordingly, like reference numerals are used for like parts from the embodiment of FIGS. 2-4, for example. Those skilled in the art will recognize that the actuator embodiment of FIG. 14 is a different manual actuator design from the embodiment of FIG. 1 (and hence is denoted 12′ herein,) however, the actuator design is optional as noted hereinabove. Also, FIG. 14 and FIG. 15 are a longitudinal cross-sectional view as is FIG. 1 but with the valve rotated 180° from the orientation of FIG. 1.

From FIG. 2 it will be noted that the seal element 72 is securely mounted in the valve body 50 such as by a press fit or other means as needed. The flow element 74 sealingly translates axially within the internal bore 85. Therefore, the tolerances on the valve body 50 press fit with the seal element 72 are closely controlled to maintain concentricity between the flow element 74 and the seal element bore 85, in order to permit smooth axial movement of the flow element 74 and a good seal.

In order to reduce the need for tight tolerances on this press fit assembly, the alternative embodiment of FIGS. 14 and 15 may be used. As best illustrated in FIG. 15, in an embodiment, the seal element 200 may be formed as a stepped or segmented one-piece body or insert 202. The body 202 preferably has no ports, orifices or other openings through the inside diameter surfaces (212, 214) so that flow from the flow element 74 through the body 202 is axial (note that this aspect is also used in the embodiment of FIGS. 1-6.) The body 202 may include a first or press-fit portion 204 and a second or seal portion 206. The first portion 204 has an outside diameter surface 208 that may be press-fit into the valve body bore 78 to fix the position of the seal element 200 axially with respect to the flow element 74. The second portion 206 has a reduced outside diameter surface 210 as compared with the outside diameter surface 208 of the first portion 204. The second portion 206 further has an inside diameter surface 212 that functions as a seal surface for the seal interface against the outer diameter seal surface 213 of the flow element 74. Therefore, the inside diameter surface 212 may have close tolerance with the flow element 74 to provide the desired seal effectiveness needed and as described hereinabove. Note that in the exemplary embodiment, the porting of the valve body 50 permits the second portion 206 to be positioned within the valve body 50 without any constraint or contact with the outside diameter surface 210. Accordingly, there is no distortion of the seal surface 212 as a result of the press-fit installation of the seal element 200 into the valve body bore 78.

The first portion 204 has an inside diameter surface 214 that is greater than the diameter of the inside diameter surface 212 of the second portion 206. Therefore, the flow element 74 easily fits through the first portion 204 and does not need to have tight tolerance therewith.

A transition portion 216 that may be tapered or otherwise stepped or shaped as needed is provided that joins the first portion 204 and the second portion 206. The transition portion 216 provides a preferably first tapered transition 218 between the outside diameter surface of the first portion 204 with the outside diameter surface of the second portion 206. The transition portion 216 also provides a preferably second tapered transition 220 between the inside diameter surface 214 of the first portion 204 with the inside diameter surface 212 of the second portion 206. The transition portion 216 therefore preferably has a thinner wall thickness 222 as compared with the wall thickness 224 of the first portion 204 and the wall thickness 226 of the second portion 206. The wall thicknesses 224 and 226 may be but need not be the same as each other. In effect, the second portion 206 is cantilevered from the first portion 204 by the transition portion 216. This has the advantageous feature that the transition portion 216 separates or segments axially the press-fit portion 204 and the seal portion 206. Therefore, any stress and distortion of the seal element 200 caused by the press-fit assembly into the valve body bore 78 is taken up by the transition portion 216 and does not affect or distort the concentricity of the seal portion 206 and the flow element 74. This avoids distortion particularly of the seal surface 212 with respect to the flow element 74. In other words, the transition portion 216 in effect axially isolates or separates the press-fit portion 204 from the seal portion 206. The press-fit portion 204, the transition portion 216 and the seal portion 206 preferably are aligned along a reference axis, such as for example the axis X with the transition portion 216 axially between the first portion 204 and the second portion 206.

It is intended that the inventions not be limited to the particular exemplary embodiments disclosed for carrying out the inventions, but that the inventions will include all embodiments falling within the scope of the appended claims.

I claim:

1. Flow control device, comprising:
a body comprising a flow path having a first portion and a second portion,
a flow element comprising at least one flow opening,
a seal element disposed between said first portion and said second portion, said flow element being operable with said seal element to control flow between said first portion and said second portion,
said at least one flow opening presenting a first flow area when said flow element is in a first position, and said at least one flow opening presenting a second flow area when said flow element is in a second position.

2. The flow control device of claim 1 wherein said first position and said second position of said flow element are relative to a reference axis.

3. The flow control device of claim 2 wherein said at least one flow opening comprises a single flow opening having a flow area that varies in relation to said reference axis.

4. The flow control device of claim 3 wherein said single flow opening comprises a tapered slot.

5. The flow control device of claim 2 wherein said at least one flow opening comprises a plurality of discrete flow openings disposed relative to said reference axis.

6. The flow control device of claim 5 wherein said plurality of discrete flow opening comprise two openings having overlapping ends that are radially separated.

7. The flow control device of claim 1 wherein said at least one flow opening presents a maximum flow area at an end portion of said at least one flow opening.

8. The flow control device of claim 1 wherein said at least one flow opening presents a minimum flow area at an end portion of said at least one flow opening.

9. The flow control device of claim 1 wherein said seal element blocks flow between said first portion and said second portion when said flow element is in a third position.

10. The flow control device of claim 1 wherein said flow element comprises a hollow member and said at least one flow opening is provided by an opening through a wall of said hollow member.

11. The flow control device of claim 10 wherein said seal element seals against an outer surface of said flow element.

12. The flow control device of claim 11 wherein a flow path between said first portion and said second portion comprises a flow portion through said at least one opening and said hollow member.

13. The flow control device of claim 1 wherein said at least one flow opening comprises a pore structure in a porous member.

14. The flow control device of claim 1 comprising an actuator that is operable to translate said flow element between said first position and said second position and a third position, wherein between said first position and said second position said at least one flow opening presents a first average rate of change of said flow area, and between said second position and said third position said at least one flow opening provides a second average rate of change of said flow area that is different from said first average rate of change.

15. A flow element for a flow control device, comprising:
a hollow body comprising at least one flow opening in a wall of said hollow body, said at least one flow opening having a first flow area at a first position relative to a reference axis and a second flow area at a second position on said reference axis.

16. Flow control device, comprising:
a body comprising a flow path having a first portion and a second portion,
a flow element comprising an orifice having a variant flow area,
a seal element disposed between said first portion and said second portion, said flow element being operable with said seal element to control flow between said first portion and said second portion,
said orifice presenting a first flow area when said flow element is in a first position, and said orifice presenting a second flow area when said flow element is in a second position.

17. The flow control device of claim 16 wherein said first position and said second position of said flow element are relative to a reference axis.

18. The flow control device of claim 16 wherein said orifice comprises a pore structure in a porous member.

19. Metering valve, comprising:
a body comprising a flow path having a first portion and a second portion,
a flow element comprising a hollow tube and an orifice in said hollow tube, said orifice comprising a variant flow area,
a seal element disposed between said first portion and said second portion, said flow element being operable with said seal element to control flow between said first portion and said second portion,
said orifice presenting a first flow area when said flow element is in a first position, and said orifice presenting a second flow area when said flow element is in a second position.

20. The flow control device of claim 19 wherein said first position and said second position of said flow element are relative to a reference axis.

21. The flow control device of claim 19 wherein said orifice comprises a pore structure in a porous member.

22. The flow control device of claim 1 in combination with an actuator that is operable to move said flow element between said first position and said second position.

23. The flow control device of claim 16 in combination with an actuator that is operable to move said flow element between said first position and said second position.

24. The metering valve of claim 19 in combination with an actuator that is operable to move said flow element between said first position and said second position.

25. Flow control device, comprising:
a body comprising a flow path having a flow path first portion and a flow path second portion,
a flow element comprising at least one flow opening,
a seal element disposed between said flow path first portion and said flow path second portion, said flow element being operable with said seal element to control flow between said flow path first portion and said flow path second portion,
said seal element comprising a seal element first portion that is press-fit into a bore of said body, and a seal element second portion that admits said flow element and seals against an outer surface of said flow element, and a transition portion that joins said seal element first portion and said seal element second portion,
said seal element first portion having an outside diameter, said seal element second portion having an outside diameter, wherein said seal element first portion outside diameter is greater than said seal element second portion outside diameter.

26. A seal element for a flow control device, comprising:
a one-piece body comprising a first portion, a second portion, and a transition portion that joins said first portion and said second portion so that said first portion, said second portion and said transition portion align along a reference axis,
said first portion having an outside diameter, said second portion having an outside diameter, wherein said first portion outside diameter is greater than said second portion outside diameter.
